(19) United States
(12) Patent Application Publication
(10) Pub. No.: US 2016/0117060 A1
(43) Pub. Date: Apr. 28, 2016

(54) METHOD AND CONTROL APPARATUS FOR PROVIDING USER INTERFACE

(71) Applicant: Hyundai Motor Company, Seoul (KR)

(72) Inventor: Sung Un Kim, Yongin (KR)

(21) Appl. No.: 14/809,235

(22) Filed: Jul. 26, 2015

(30) Foreign Application Priority Data
Oct. 22, 2014 (KR) 10-2014-0143296

(51) Int. Cl. G06F 3/0482; G06F 3/041; G06F 3/0484

(52) U.S. Cl. CPC G06F 3/0482; G06F 3/0484; G06F 3/0418

(57) ABSTRACT

A method and a control apparatus for providing a user interface are provided. The control apparatus includes an operating unit, a display that is configured to display user interface, and a controller. The controller is configured to detect an erroneous operation of the operating unit based on respective menus that are included in the user interface. In addition, the controller is configured to operate the display to display guide information for guiding an operation method of the operating unit with respect to a menu with the detected erroneous operation.

### CROSS-REFERENCE TO RELATED APPLICATION

This application claims priority to and the benefit of Korean Patent Application No. 10-2014-0143296 filed in the Korean Intellectual Property Office on Oct. 22, 2014, the entire contents of which are incorporated herein by reference.

### BACKGROUND

(a) Field of the Invention

The present invention relates to a method and a control apparatus for providing a user interface.

(b) Description of the Related Art

Vehicle operators should be able to easily control operating units within a vehicle to prevent distractions while driving the vehicle. The operating unit within the vehicle may include a rotary operating unit, a button-type operating unit, and a tilt-type operating unit. In recent years, research have been actively performed regarding method of mounting a display within a vehicle used to operate various electronic devices such as air conditioning devices.

Meanwhile, a user Interface (UI) on a display device within the vehicle configured to displaying menus according to the related art non-intuitively and frequently matches operations of the operating unit such as movement between menus and adjustment of a parameter. The non-intuitive matching of the UI with the operation of the operating unit causes confusion in operation of the menus and difficulty in menu control. Particularly, when a user having no ordinary skill in the art controls the menus, non-intuitive matching of the UI with the operating unit accelerates confusion of the user to deteriorate menu access. In addition, when the driver controls the menus while driving the vehicle, attention of the driver may be distracted which threatens safe driving.

The above information disclosed in this section is merely for enhancement of understanding of the background of the invention and therefore it may contain information that does not form the prior art that is already known in this country to a person of ordinary skill in the art.

### SUMMARY

The present invention provides a method and a control apparatus for providing a user interface having advantages of allowing a user to more easily operate a display device. An exemplary embodiment of the present invention provides a control apparatus that may include: an operating unit; a display-to-display user interface; and a controller configured to detect an erroneous operation of the operating unit with respect to respective menus included in the user interface, and operate the display to display guide information for guiding an operation method of the operating unit with respect to a menu with the detected erroneous operation.

Another exemplary embodiment of the present invention provides a method for providing a user interface by a control apparatus, the method may include: detecting an erroneous operation of an operating unit with respect to menus included in the user interface; and displaying guide information for guiding an operation method of the operating unit when a menu with the detected erroneous operation is selected from the user interface.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary diagram schematically illustrating a configuration of a control apparatus according to an exemplary embodiment of the present invention;

FIG. 2 is an exemplary flowchart illustrating a method for providing a user interface in a control apparatus according to an exemplary embodiment of the present invention; and

FIG. 3 is an exemplary diagram illustrating an example of providing a user interface in a control apparatus according to an exemplary embodiment of the present invention.

### DESCRIPTION OF SYMBOLS

100: control apparatus

110: display

120: operating unit

130: sensor unit

140: driving unit

150: memory

160: controller

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

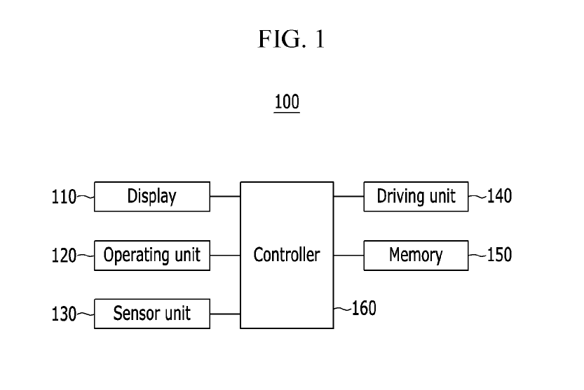

FIG. 1 is an exemplary diagram schematically illustrating a configuration of a control apparatus according to an exemplary embodiment of the present invention. The control apparatus according to an exemplary embodiment of the present invention may include control apparatuses such as an audio video navigation (AVN) system, and a center fascia mounted within the vehicle.

Referring to FIG. 1, the control apparatus 100 according to an exemplary embodiment of the present invention may include a display 110, an operating unit 120, a sensor unit 130, a driving unit 140, a memory 150, and a controller 160. Since constituent elements shown in FIG. 1 are not essential, a control apparatus 100 according to an exemplary embodiment of the present invention having more or less constituent elements may be implemented. The controller 160 may be configured to operate the various units of the control apparatus 100.

The display 110 may be configured to display information processed by the control apparatus 100. For example, the display 110 may be configured to display a user interface (UI) including menus associated with various functions of devices within the vehicle. When the display 110 forms a layer structure with a touch sensor (not shown) the display 110 may be implemented as a touch screen. The touch screen represents an input touchable display. The operating unit 120 may be a user input device controlled or manipulated by a user, and may be configured to receive user inputs such as touch, rotation, tilt, pressure input, and button operations. The operating unit 120 may include a touch-type operating unit configured to receive touch input, a rotation-type operating unit configured to receive rotation inputs such as a wheel, a tilt-type operating unit configured to receive tilt input, and a button-type operating unit where button input is possible.

The sensor unit 130 may be coupled with the operating unit 120 and may be configured to detect contact of the user (e.g., pressure exerted there onto) with the operating unit 120. The sensor unit 130 may include a capacitive or impedance touch sensor and pressure sensor. The driving unit 140 may be configured to receive various control signals from the controller 160, and may be configured to operate various electronic devices such as an air conditioner, a navigation device, and a multi-media device mounted within or extraneous to the vehicle. The memory 150 may include programs to operate the controller 160 and various data to be processed by the control apparatus 100. The memory 150 may be configured to store data associated with the UI to be displayed on the display 110.

For example, the memory 150 may be configured to store graphic data for displaying the UI, connection information between layers of menus to be displayed as the UI, cooperation information between the UI and the operating unit 120, and UI setting information. The graphic data for displaying the UI may include image data of each graphic object (e.g., list, button, texts, icons, cursor, and the like) constituting the UI, and a display position of each graphic object. The connection information between layers of menus to be displayed as the UI may include connection relations between layers of each menu, where the menus may be classified into a plurality of layers based on a depth.

The cooperation information between the UI and the operating unit 120 may include user input information allowed by menus. In other words, the cooperation information may include information regarding user input which may be input via the operating unit 120 to move to another menu or another screen or to execute a function that corresponds to the menu when each menu is selected. For example, when a current brightness adjustment menu is selected, when movement to another menu is possible using left or upper/lower direction tilt of the operating unit 120, and brightness may be adjusted by clockwise/counter-clockwise rotation of the operating unit, user input which may be input corresponding to a brightness adjustment menu may include left direction tilt, upper/lower direction tilt, and clockwise/counter-clockwise rotation. In contrast, the tilt in the left direction may not be included in user input which may be input associated with the brightness adjustment menu.

The cooperation information between the UI and the operating unit 120 may include function information that corresponds to user input with respect to each menu. In other words, the cooperation information may include information regarding which function is executed when particular user input with respect to each menu is received. For example, a menu movement function based on a tilt direction with respect to tilt input may be stored corresponding to the brightness adjustment menu, and a brightness adjustment function based on a rotating direction with respect to rotation input may be stored corresponding to the brightness adjustment menu.

The UI setting information may include setting information associated with UI such as a UI display form, screen brightness, and presence of operation guide display. The memory 150 may be configured to store operation guide information to connect an operation of the operating unit 120 to respective menus included in the UI. The operation guide information may be information used to guide user input allowed by menus and a function that corresponds to each user input, and may include a type and an operation method of the operation unit 120 for receiving corresponding user input with respect to each user input allowed by menus, and a graphic object that represents a function executed based on a corresponding user input.

The memory 150 may be configured to generate data associated with an erroneous operation of the operating unit 120 with respect to the UI into a database to store the data. The information associated with the erroneous operation may include detection of the erroneous operation with respect to each menu and the number of erroneous operations. The controller 160 may be configured to execute an overall operation of the control apparatus 100. In particular, the controller 160 may be configured to operate the UI displayed on the display 110 based on the data associated with the UE stored in the memory 150. For example, the controller 160 may be configured to receive user input for movement between menus via the operating unit 120, and may be configured to move a position of a cursor or change a menu screen based on the received user input.

The controller 160 may further be configured to detect the erroneous operation of the operating unit 120 based on the cooperation information between the UI and the operating unit 120. When the user input received through the operating unit 120 is not user input allowed in a current UI state, the controller 160 may be configured to determine the received input as an erroneous operation. For example, when user input based on wheel rotation is received when upward/downward tilt for movement between menus is allowed in a currently selected menu, the controller 160 may be configured to detect the input as the erroneous operation. The allowance within a selected menu may mean a type of movement that may be used to operate or select items within a menu.

When an erroneous operation of the operation unit 120 is detected, the controller 160 may be configured to store the number of detection times of error operations by corresponding the number of detection times of erroneous operations to a menu in which an error operation is detected. The controller 160 may be configured to operate the display 110 to display operation guide information that corresponds to a currently selected menu among the UI displayed on the display 110 based on the operation guide information stored in the memory 150. Further, the controller 160 may be configured to operate UI setting information, presence of the user contact (e.g., pressure exerted onto) with the operating unit 120, detection of the erroneous operation, and display presence of operation guide information based on the number of detection times of the erroneous operations.

For example, when display of the operation guide information is allowed in the UI setting information, the controller 160 may be configured to operate the display 110 to display the operation guide information. Accordingly, at the initial time when the user input is poor operating (e.g., is not allowed) at UI operation, the user may set the UI setting information to display operation guide information. When the user input is good operating (e.g., allowed) at UI operation, display of the operation guide information is not needed so display of the operation guide information may be inactivated.

Further, for example, when the contact of the user with the operating unit 120 is detected by a sensor unit 130, the display of the operation guide information may be activated. That is, the sensor unit 130 may be configured to sense pressure being exerted onto the operating unit 120. Accordingly, the user may view operation guide information when operation is desired to prevent a screen from being shielded due to an operation guide in a state of having no operation. Meanwhile, in response to determining whether the operation guide information is displayed based on the contact with the operating unit 120, the controller 160 may be configured to display the operation guide information. When the user input is not received for a preset period of time or greater or the contact with the operating unit 120 is not detected, the controller 160 may be configured to inactivate the display of the operation guide information (e.g., a sleep mode may be entered).

Further, for example, the controller 160 may be configured to display the operation guide information with respect to a menu in which an erroneous operation occurs among menus included in the UI. In particular, the controller 160 may be configured to determine that a menu having a greater number of erroneous operation detections than a predetermined number is a menu which the user has difficulty in accessing to activate the display of the operation guide information. The controller 160 may be configured to inactivate the display of the operation guide information with respect to a menu when no erroneous operation is detected for a predetermined time. The controller 160 may be configured to receive user input through the operating unit 120, to output control input for operating the driving unit 140 to the driving unit 140 based on the received user input.

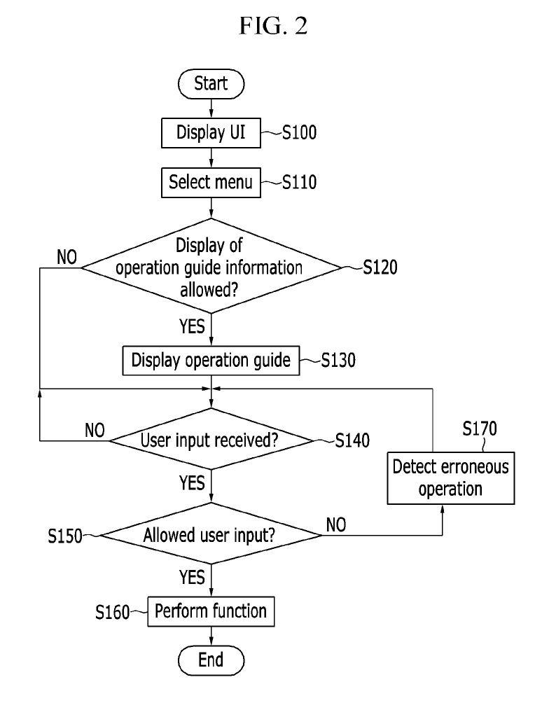

FIG. 2 is an exemplary flowchart illustrating a method for providing a user interface in a control apparatus according to an exemplary embodiment of the present invention. Referring to FIG. 2, a control apparatus 100 may be configured to display a UI selected by a user on a display 100 based on user input received through an operating unit 120 (S100). Further, a user selection of one menu from the UE displayed on the display 110 may be received (S110).

In step S110, when the user input for moving the menu is not received, the control apparatus 100 may be configured to select a menu set as a default menu. Additionally, when the user input for moving the menu is received, the control apparatus 100 may be configured to select one menu from the UI based on the received user input. In step S110, when the one menu is selected, the control apparatus 100 may be configured to display an indicator for indicating the selected menu, for example, a cursor, a box, and a pointer that corresponds to the selected menu, or may be configured to highlight and display the selected menu. Accordingly, the user may be able to recognize which menu is currently selected. When the one menu is selected in step S 110, the control apparatus 100 may be configured to determine whether display of operation guide information is allowed (S120).

In step S120, the control apparatus 100 may be configured to determine whether the display of operation guide information is allowed based on the UE setting information, whether a user contacts the operating unit 120, detection of an erroneous operation, and the number of erroneous operation detections. In step S120, when the display of the operation guide information is allowed, a controller 160 may be configured to display the operation guide information on the display 110 (S130). Further, in step S120, when the display of operation guide information is not allowed, the controller 160 may be configured to inactive (e.g., enter sleep mode) the display of the operation guide information associated with the selected menu.

Moreover, when one menu is selected, the control apparatus 100 may be configured to wait for reception of the user input through the operating unit 120 associated with the selected menu (S140). Next, when the user input is received, the controller 160 may be configured to determine whether the received user input is allowed user input in a current selected menu (S150). In step S 150, when the received user input is the allowed user input, the control apparatus 100 may be configured to perform a function that corresponds to the received user input associated with the current selected menu (S160). Additionally, in step S150, when the received user input is the allowed user input, the control apparatus 100 may be configured to detect an erroneous operation (S170), and update erroneous operation relation information stored in the memory 160.

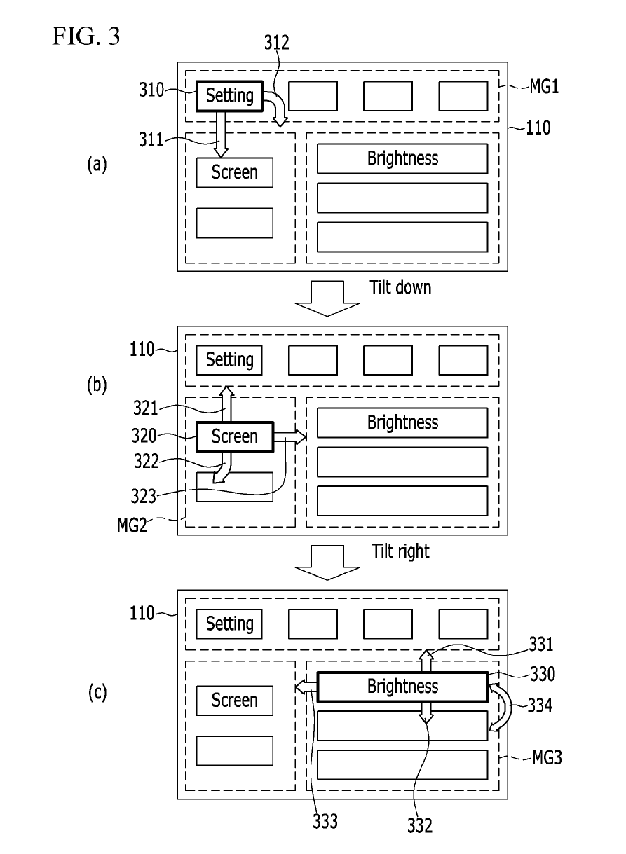

FIG. 3 is an exemplary diagram illustrating an example of providing user interface in a control apparatus according to an exemplary embodiment of the present invention. Referring to FIG. 3, to adjust screen brightness of the display 110, a setting menu 310 which is an upper menu associated with the screen brightness in the UI may be selected. When the setting menu 310 is selected, the display 110 locates a cursor at the setting menu 310 from the UI as shown in FIG. 3(a). Further, the display 110 may be configured to display operation guide information 311 and 312 associated with the setting menu 310.

Referring to FIG. 3(a), to move the setting menu 310 to a middle menu group MG2, user input that corresponds to tilt down of the operating unit 120 may be input. Further, to move the setting menu 310 to another menu in the same menu group MG1, a user input may be received that corresponds to clockwise rotation of the operating unit 120. Accordingly, the control apparatus 100 may be configured to guide an operating method of the operating unit 120 associated with the setting menu 310 to the user by displaying an arrow 311 indicating tilt down and an arrow 312 indicating the clockwise rotation at a position that corresponds to a moving direction. When the tilt down is input, the controller of the display 110 may be configured to select a screen menu 320 of the middle menu group MG2, and move the cursor to the selected menu as illustrated in FIG. 3(b). Further, the display 110 may be operated to display operation guide information 321, 322, and 323 associated with the screen menu 320.

Referring to FIG. 3(b), to move the screen menu 320 to a lower menu group MG3, user input may be received that corresponds to tilt right of the operating unit 120. Further, to move the selection menu 320 to an upper menu group MG1, a user input may be received that corresponds to tilt up of the operating unit 120. To move the selection menu 320 to another menu in the same menu group MG2, a user input may be received that corresponds to clockwise rotation of the operating unit 120. Accordingly, the control apparatus 100 may be configured to guide the operating method of the operating unit 120 associated with the screen menu 320 to the user by displaying an arrow 321 indicating tilt up, an arrow 322 indicating downward rotation, and an arrow 323 indicating tilt right at a position that corresponds to a moving direction. After that, when the tilt right is input, the display 110 may be operated to select a brightness menu 330 of a lower menu group MG3, and move the cursor to the selected menu 330 as illustrated in FIG. 3(c). Further, the display 110 may be configured to display operation guide information 331, 332, 333, and 334 associated with the brightness menu 320.

Referring to FIG. 3(c), to move the brightness menu 330 to a middle menu group MG2, a user input may be received that corresponds to tilt left of the operating unit 120. To move the brightness menu 330 to the upper menu group MG1, a user input may be received that corresponds to tilt up of the operating unit 120. In addition, to move the brightness menu 330 to another menu in the same menu group MG3, a user input may be received that corresponds to the tilt down of the operating unit 120. Furthermore, to adjust brightness of the display 120 through the brightness menu 330, a user input may be received that corresponds to clockwise/anticlockwise rotations of the operating unit 120. Accordingly, the control apparatus 100 may be configured to guide an operating method of the operating unit 120 associated with the brightness menu 330 to the user by displaying an arrow 331 that indicates tilt up, an arrow 332 that indicates tilt down, an arrow 333 that indicates tilt left, and an arrow 334 that indicates the clockwise/anticlockwise rotations at a position that corresponds to a moving direction.

As described above, an exemplary embodiment of the present invention may be configured to display operation guide information that allows the user to more easily recognize a menu operation method. Accordingly, menu operation convenience of the user may be improved. When the menu is to be operated while driving, attention distraction of the driver may be minimized to improve safe driving.

In addition, the user may select whether to display the operation guide information. Inconvenience of the user shielding a screen due to the display of the operation guide information may be minimized by displaying the operation guide information in response to determining that there is a user intention to operate the operating unit or displaying the operating guide information with respect to a menu which the user frequently and erroneously operates after detecting the contact of the user with the operating unit.

Meanwhile, although an exemplary embodiment of the present invention describes that the control apparatus 100 includes one display 110 by way of example, the control apparatus 100 may include at least two displays according to another exemplary embodiment of the present invention. In particular, the control apparatus 100 may be configured to display UI including menus and the operation guide information on different displays.

The method for providing user interface according to an exemplary embodiment of the present invention may be implemented in software. When the method for providing user interface according to an exemplary embodiment of the present invention is implemented in software, constituent elements of the present invention include code segments to execute necessary operations. Program or code segment processors may be stored in a readable medium or may be transmitted according to a computer data signal coupled with a carrier signal in a transmission medium or a communication network.

A computer readable medium computer includes various types of recording devices to store data which may be read by a computer system. For example, the computer readable recording device includes a ROM, a RAM, a CD-ROM, a DVD_ROM, a DVD_RAM, a magnetic tape, a floppy disk, a hard disk, an optical data storage device, and the like. Further, the computer readable recording medium is distributed in a computer device connected to a network, and a computer readable code is distributed and stored in the computer readable recording medium to be executed.

While this invention has been described in connection with what is presently considered to be exemplary embodiments, it is to be understood that the invention is not limited to the disclosed exemplary embodiments. On the contrary, it is intended to cover various modifications and equivalent arrangements included within the spirit and scope of the appended claims.

What is claimed is:

1. A control apparatus, comprising:
an operating unit;
a display-to-display user interface; and
a controller configured to:
detect an erroneous operation of the operating unit based on respective menus included in the user interface; and
operate a display to output guide information for guiding an operation method of the operating unit with respect to a menu with the detected erroneous operation.

2. The control apparatus of claim 1, wherein the controller is configured to receive user input through the operating unit, and determine that the erroneous operation occurs when the user input is not allowed in a current selected menu.

3. The control apparatus of claim 2, wherein the controller is configured to operate the display to output the guide information with respect to a menu having a number of erroneous operation detections equal to or greater than a preset number of detections for a preset period of time, and inactivate the display of the guide information with respect to a menu in which the erroneous operation is not detected for the preset period of time.

4. The control apparatus of claim 1, further comprising:
a sensor unit configured to detect contact with the operating unit,
wherein the controller is configured to operate the display to output the guide information when the sensor unit detects the contact with the operating unit.

5. A method for providing a user interface by a control apparatus, the method comprising:
detecting, by a controller, an erroneous operation of an operating unit with respect to menus included in the user interface; and
displaying, by the controller, guide information for guiding an operation method of the operating unit when a menu with the detected erroneous operation is selected from the user interface.

6. The method of claim 5, wherein the detecting of the erroneous operation of an operating unit includes:
receiving, by the controller, a user input through the operating unit; and
detecting, by the controller, the erroneous operation when the user input is not allowed with respect to a current selected menu.

7. The method of claim 5, wherein the displaying of the guide information includes:
displaying, by the controller, the guide information when contact with the operating unit is detected.

8. The method of claim 5, wherein the displaying of the guide information includes:
displaying, by the controller, guide information for guiding an operating method of the operating unit when the number of erroneous operation detections with respect to a menu with the detected erroneous operation is equal to or greater than a preset number of detections.

9. A non-transitory computer readable medium containing program instructions executed by a controller, the computer readable medium comprising:
program instructions that detect an erroneous operation of an operating unit with respect to menus included in a user interface; and
program instructions that display guide information for guiding an operation method of the operating unit when a menu with the detected erroneous operation is selected from the user interface.

10. The non-transitory computer readable medium of claim 9, further comprising:
program instructions that receive a user input through the operating unit; and
program instructions that detect the erroneous operation when the user input is not allowed with respect to a current selected menu.

11. The non-transitory computer readable medium of claim 9, further comprising:
program instructions that display the guide information when contact with the operating unit is detected.

12. The non-transitory computer readable medium of claim 9, further comprising:
program instructions that display guide information for guiding an operating method of the operating unit when the number of erroneous operation detections with respect to a menu with the detected erroneous operation is equal to or greater than a preset number of detections.
